(19) United States
(12) Patent Application Publication
(10) Pub. No.: US 2006/0256990 A1
(43) Pub. Date: Nov. 16, 2006

(54) Hearing aid eartip

(76) Inventor: David William Holmes, Colleyville, TX (US)

Correspondence Address: KEVIN MARK KLUGHART, 2516 LILLIAN MILLER PARKWAY, SUITE 115, DENTON, TX, 76210-7205, US

(21) Appl. No.: 11/231,574

(22) Filed: Sep. 20, 2005

Related U.S. Application Data
(60) Provisional application No. 60/679,806, filed on May 11, 2005.

(51) Int. Cl. H04R 25/00

(52) U.S. Cl. 381/330

(57) ABSTRACT

A hearing aid eartip is disclosed for use with an over-the-ear hearing aid which incorporates a means for accepting a detachable wax guard for the purposes of preventing wax buildup in the hearing aid sound transmission tube. The disclosed invention is effective at transmitting sound from an over-the-ear hearing aid to the patient's ear canal, is easily inserted into the patient's ear canal, and provides for a more aesthetically pleasing form factor than the prior art. The disclosed invention controls cerumen, improves overall hearing aid gain, and reduces unwanted hearing aid feedback.

### CROSS REFERENCE TO RELATED APPLICATIONS

Applicant claims benefit pursuant to 35 U.S.C. §119 and hereby incorporates by reference Provisional Patent Application for “HEARING AID EARTIP”, Ser. No. 60/679,806, docket DWH-2005-003, filed May 11, 2005, and submitted to the USPTO with Express Mail on May 11, 2005 with tracking number ER618468149US.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention is related to the control of ear wax (cerumen) as it applies to the use of a hearing aid eartip assembly. The present invention presents a hearing aid eartip that prevents the buildup of ear wax by permitting a variety of ear wax guards to be mated to an in-the-ear hearing aid eartip for use in conjunction with an over-the-ear (also referred to as a “behind-the-ear”) hearing aid. This combination provides enhanced hearing aid performance and ease of maintenance with respect to disposal or cleaning of ear wax guards in comparison to the prior art.

### PRIOR ART AND BACKGROUND OF THE INVENTION

### Prior Art Context (0100)

The prior art context in which the present invention may be generally applied is illustrated in FIG. 1 (0100) (as disclosed in U.S. Design Pat. 506,258), wherein a hearing aid eartip (0101) connects to a sound tube (0102) which transmits amplified sound from an over-the-ear hearing aid (0103). These configurations may optionally include a retaining clip (0104) to aid in retaining the position of the hearing aid eartip in the ear canal.

The present invention is directed towards the construction of the hearing aid eartip (0101) within this system context. Traditionally, these hearing aid eartips have been constructed using a convex structure as illustrated in FIG. 1 (0101). The present invention departs significantly from this design methodology by adopting a concave eartip structure.

### Overview (0200, 0300, 0400 0500)

The prior art with respect to the present invention is generally illustrated in FIGS. 2-5 ( 0200, 0300, 0400, 0500), wherein the problem being addressed is the control of ear wax (cerumen) that tends to contaminate a hearing aid eartip or other hearing aid structure.

FIG. 2 (0200) (as disclosed in U.S. Pat. No. 6,600,492) illustrates one prior art approach to cerumen control via the use of a flap or other structure to prevent ear wax from contaminating the hearing aid eartip tube. This configuration is somewhat effective, but difficult to maintain and clean.

FIG. 3 (0300) (as disclosed in U.S. Pat. No. 6,891,956) illustrates another prior art approach to the problem wherein the cerumen control is achieved using a hearing aid structure that actually fits in the ear canal. This configuration is not amenable for use with inexpensive over-the-ear hearing aids and the like.

FIG. 4 (0400) (as disclosed in U.S. Pat. No. 6,795,562) illustrates a prior art wax guard that attaches to an in-the-ear hearing aid system. This system is somewhat difficult to manufacture, and requires special tooling to permit insertion or removal of the wax guard. It is not suitable for use with over-the-ear hearing aid systems.

FIG. 5 (0500) (as disclosed in U.S. Pat. No. 6,349,790) illustrates a prior art wax guard integrated into an in-the-ear hearing aid system. This configuration permits cleaning in some circumstances, but compromises the integrity of the hearing aid system should the wax guard need cleaning.

### Problems Associated with the Prior Art

The prior art suffers from several drawbacks, notably the inability to permit application to over-the-ear hearing aids, inability to clean and maintain the wax guard, contamination of the hearing aid structure, and inability to replace the wax guard should it become damaged or otherwise compromised or contaminated. Additionally, prior art hearing aid eartips that incorporate wax guards are generally thought to be aesthetically unpleasing to most patients.

One significant problem associated with the prior art is the use of convex eartip assemblies. These assemblies tend to allow reflected sound from the tympanic membrane to exit the ear canal around the eartip assembly. This reflected sound may in many circumstances cause feedback with over-the-ear hearing aids.

### OBJECTIVES OF THE INVENTION

Accordingly, the objectives of the present invention are (among others) to circumvent the deficiencies in the prior art and affect the following objectives:
(1) To provide a hearing aid eartip that can be fitted with a number of different wax guards.
(2) To permit a hearing aid eartip with wax guard that is easily maintained.
(3) To permit a hearing aid eartip with wax guard that is easily manufactured at a low cost.
(4) To permit a hearing aid eartip with wax guard suitable for use with an over-the-ear hearing aid.
(5) To permit a hearing aid eartip with wax guard that is aesthetically pleasing to the patient.
(6) To permit a hearing aid eartip using a concave eartip structure.
(7) To improve sound transmission to the tympanic membrane using a concave eartip structure.
(8) To redirect part of the sound energy reflected by the tympanic membrane back into the ear canal, reducing the potential for feedback.
(9) To improve overall hearing aid gain by redirecting reflected sound energy back into the ear canal.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention system context is generally illustrated in FIG. 6 (0600) wherein the hearing aid eartip (0601) is placed in the ear canal (0610). In this context, the eartip (0601) is connected to a sound tube (0602) that extends outside the ear canal (0610) to a behind-the-ear hearing aid (0703) as generally illustrated in FIG. 7 (0700). The hearing aid eartip described and claimed herein is generally illustrated by the perspective view of FIG. 8 (0800) and side view of FIG. 9 (0900).

Further detail of the preferred invention embodiment is illustrated in FIG. 10 (1000), wherein the hearing aid eartip body (1001) is designed to accept a wax (cerumen) guard (1002), having a variety of configurations. The hearing aid eartip (0601) is constructed to accept a hearing aid eartip tube (0602) connected to an over-the-ear hearing aid (not shown).

The system as generally illustrated in FIG. 10 (1000) may include a wax guard lip (1004) to prevent ear wax from contaminating the wax guard (1002). The hearing aid eartip (0601) is constructed to permit an inner surface (1005) that mates with the selected ear wax guard (1002). The distal remaining end of the hearing aid eartip is constructed to permit an inner surface (1006) that mates with the selected hearing aid eartip tube (1002).

The present invention is amenable to a variety of embodiments, some of which may not include the wax guard lip (1004), as generally illustrated in FIG. 11 (1100) and FIG. 12 (1200).

### BRIEF DESCRIPTION OF THE DRAWINGS

For a fuller understanding of the advantages provided by the invention, reference should be made to the following detailed description together with the accompanying drawings wherein:

FIG. 1 illustrates a prior art embodiment of a hearing aid system and associated eartip assembly (as disclosed in U.S. Design Pat. 506,258);

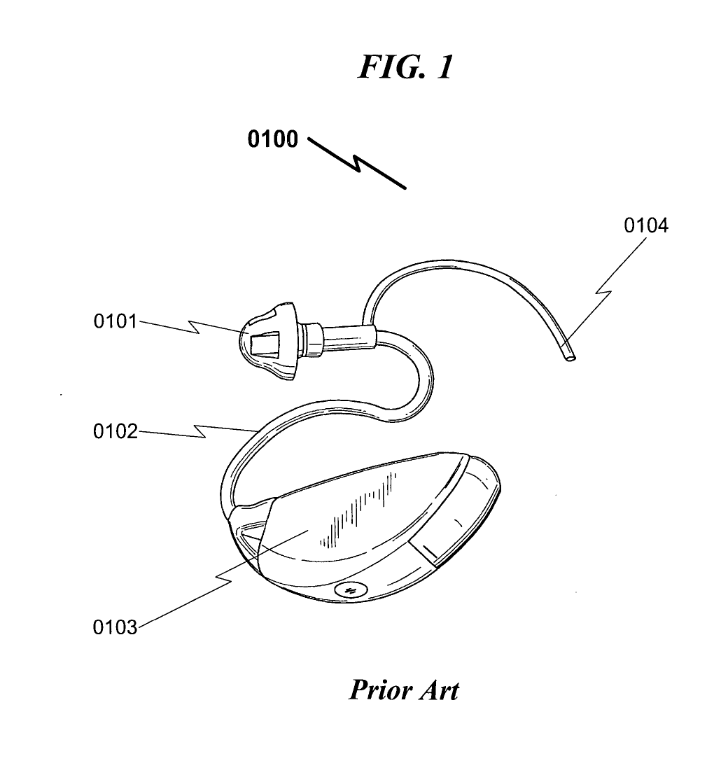

FIG. 2 illustrates a prior art embodiment of a hearing aid and associated eartip assembly (as disclosed in U.S. Pat. No. 6,600,492);

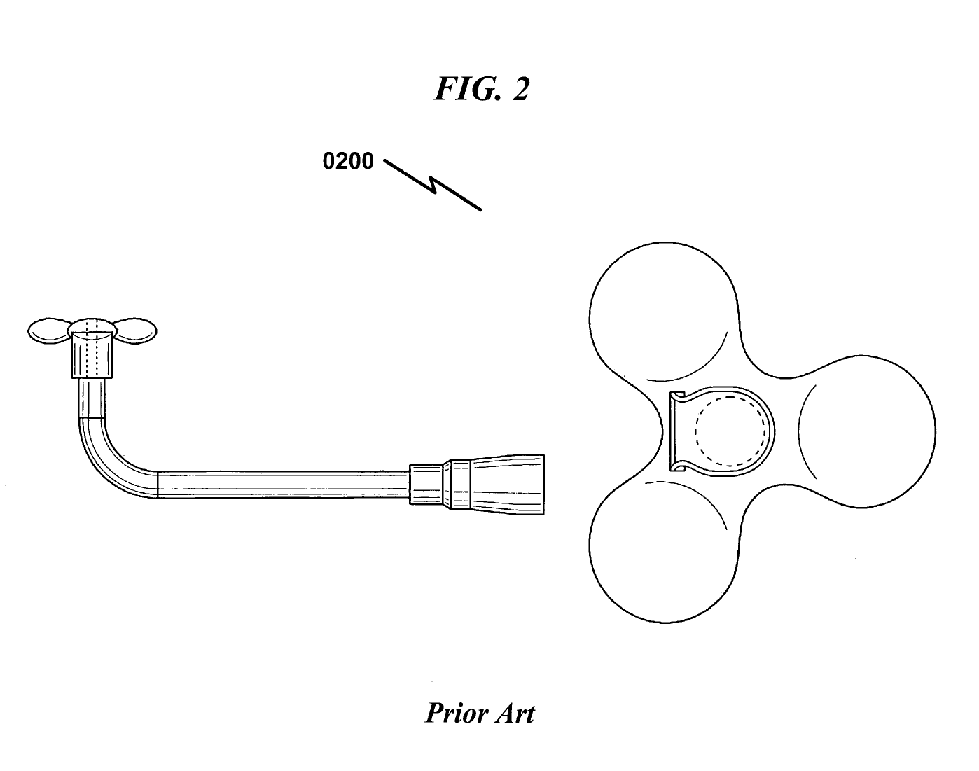

FIG. 3 illustrates a prior art embodiment of a hearing aid and associated eartip assembly (as disclosed in U.S. Pat. No. 6,891,956) incorporating an integrated wax guard;

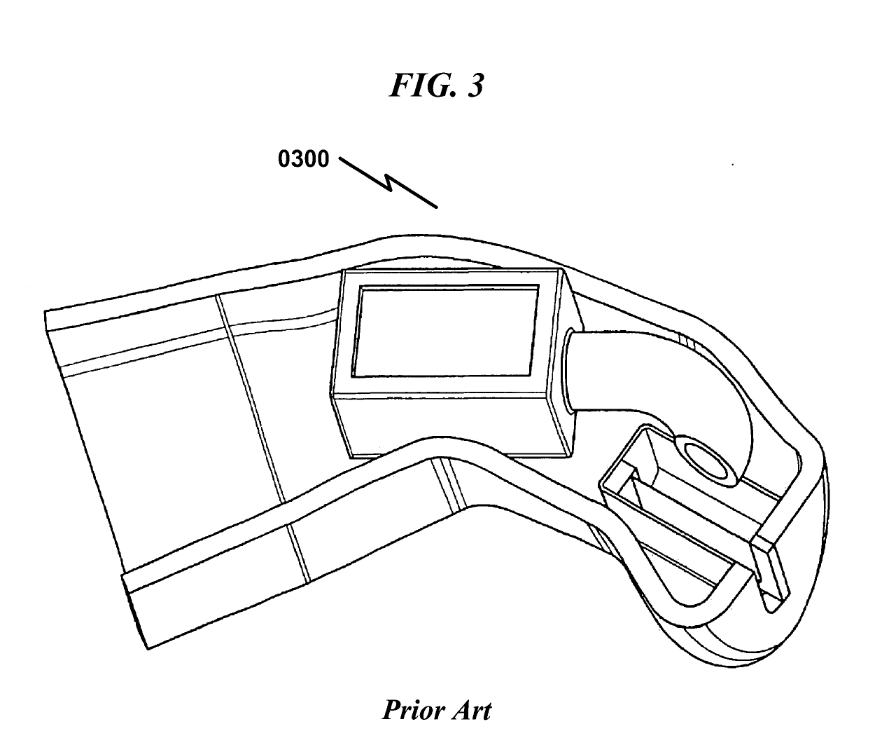

FIG. 4 illustrates a prior art embodiment of a hearing aid and associated eartip assembly incorporating a removable wax guard (as disclosed in U.S. Pat. No. 6,795,562);

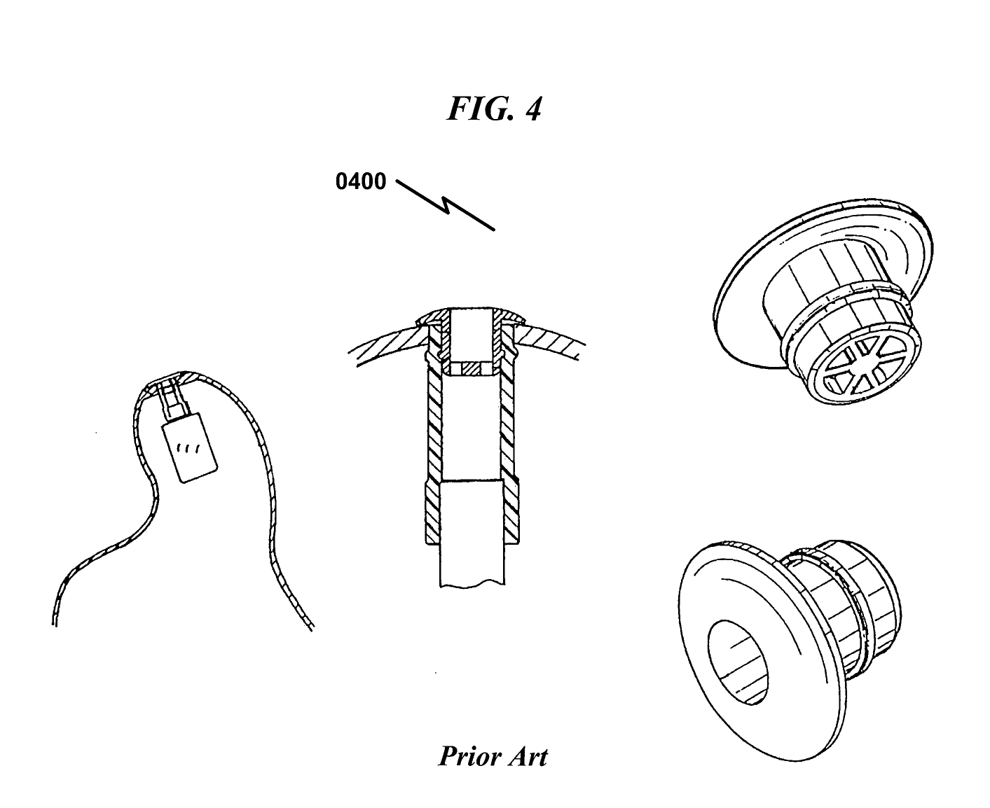

FIG. 5 illustrates a prior art embodiment of a hearing aid eartip assembly incorporating integrated wax guard (as disclosed in U.S. Pat. No. 6,349,790);

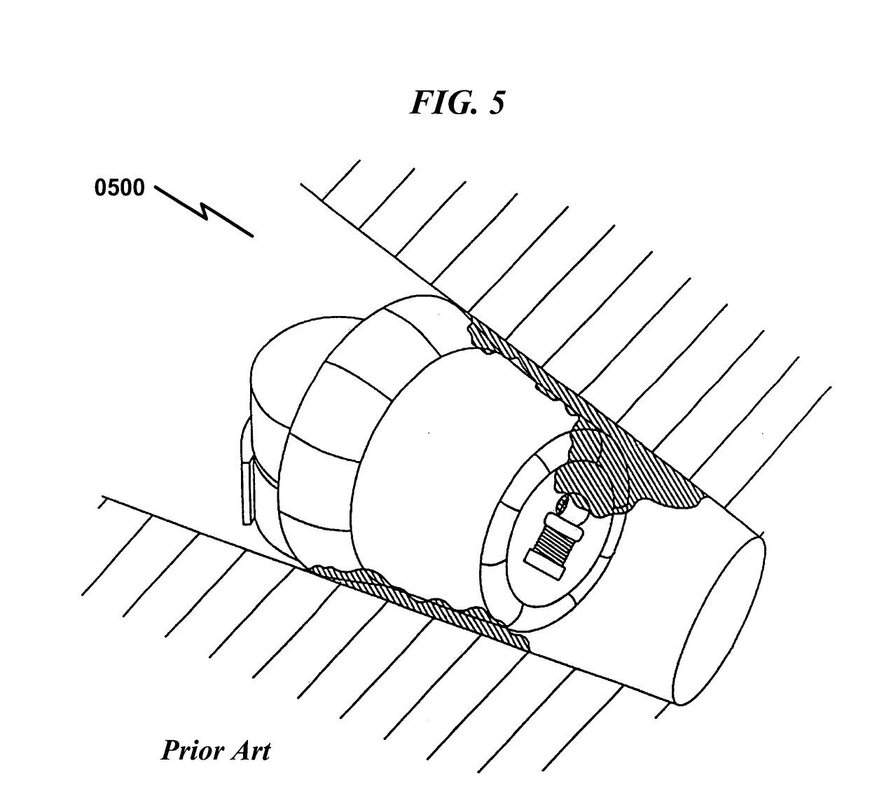

FIG. 6 illustrates a side system view of a preferred exemplary embodiment of the present invention showing placement of the hearing aid eartip within the patient ear canal;

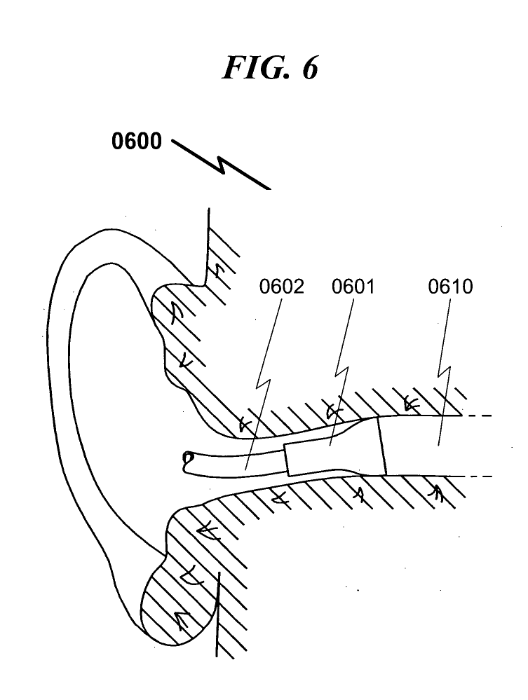

FIG. 7 illustrates an end view of a preferred exemplary system context for the present invention utilizing a behind-the-ear hearing aid;

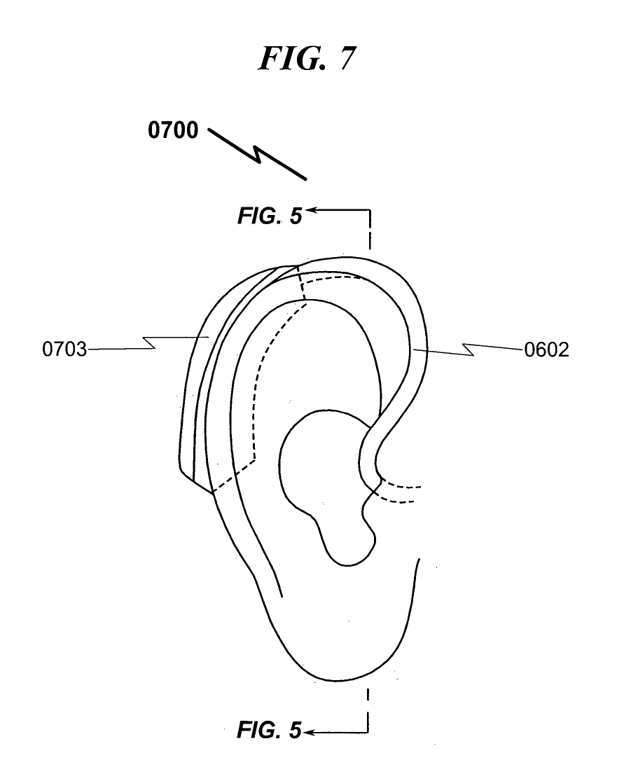

FIG. 8 illustrates a perspective view of a preferred exemplary embodiment of the present invention;

FIG. 9 illustrates a side view of a preferred exemplary embodiment of the present invention;

FIG. 10 illustrates a sectional side assembly view of a preferred exemplary embodiment of the present invention;

FIG. 11 illustrates a sectional view of an alternate preferred exemplary embodiment of the present invention;

FIG. 12 illustrates a sectional view of an alternate preferred exemplary embodiment of the present invention.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a HEARING AID EARTIP. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Exemplary System Embodiment (0500 0600 0700 0800)

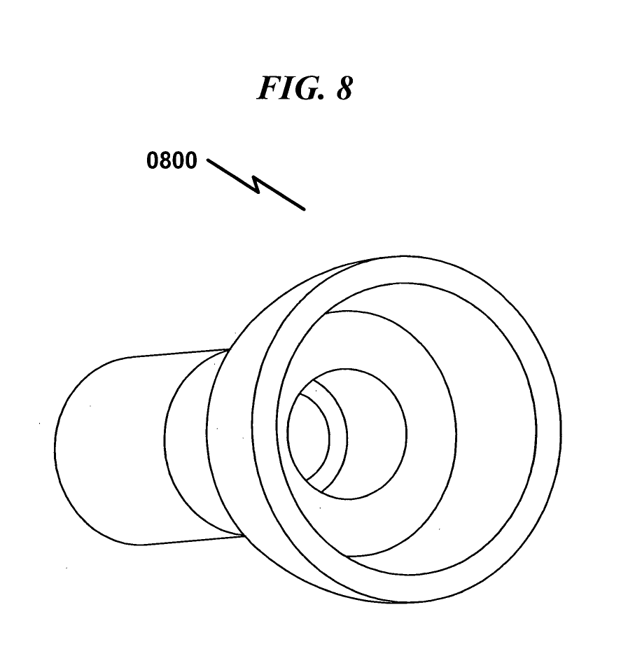

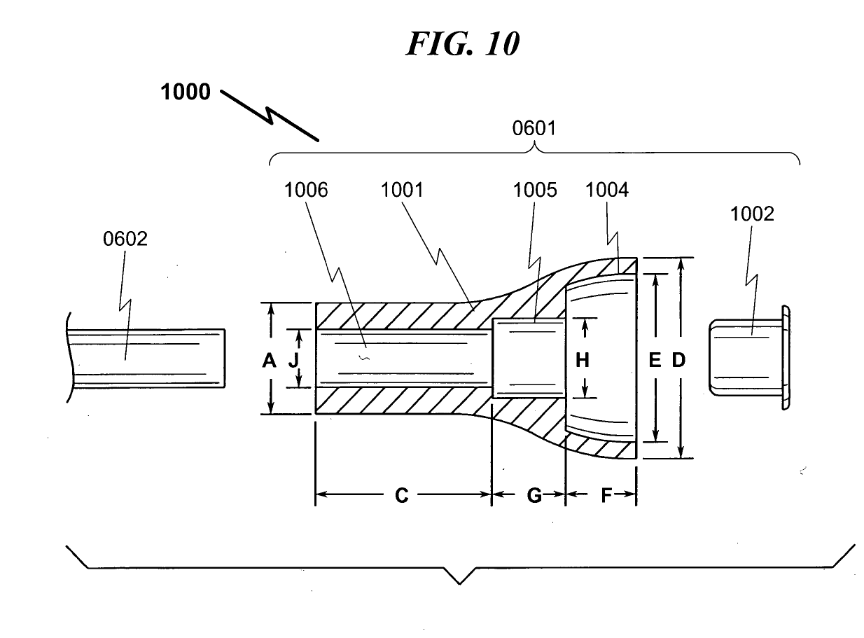

As generally illustrated in FIGS. 8-12 (0800, 0900, 1000, 1100, 1200), the present invention as embodied in the detail of FIG. 10 (1000) comprises a hearing aid eartip tube body (1001) having a hearing aid eartip tube mating surface (1006) that conforms to and mimics the outside dimension of a hearing aid eartip (0703) tube, with the eartip tube (1002) connecting the eartip (0601) to an over-the-ear hearing aid. The hearing aid eartip (0601) also incorporates a wax guard mating surface (1005) that conforms to and mimics the outside dimension of a detachable wax guard (1002). A wide variety of wax guard structures may be suitable for the present invention, and the present invention is not limited to a particular type or construction of wax guard (1002). The system as illustrated in FIG. 10 (1000) may also include a wax guard lip (1004) which extends distally from the wax guard mating surface (1005) and which prevents contamination of the detachable wax guard (1002) when the detachable wax guard (1002) is mated with the wax guard mating surface (1005).

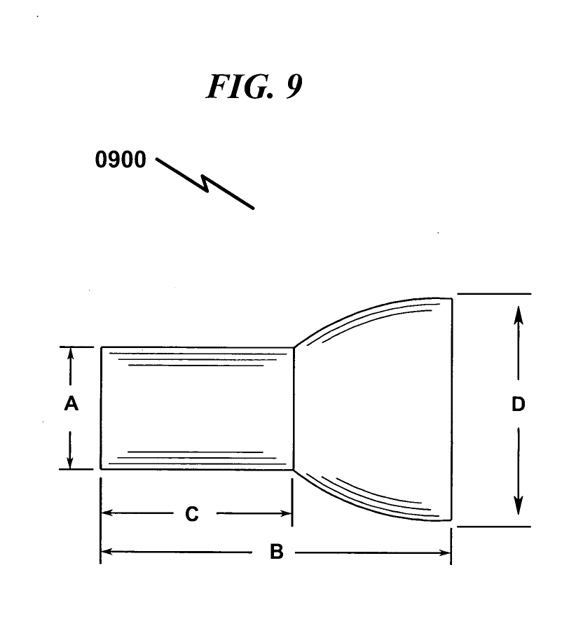

The exemplary embodiment of FIG. 10 (1000) is further illustrated in the perspective view of FIG. 8 (0800), and the side view of FIG. 9 (0900). One skilled in the art will realize that the outside structure of the hearing aid eartip (0601) may vary widely without diverging from the teachings of the present invention.

### Alternate System Embodiment (1100, 1200)

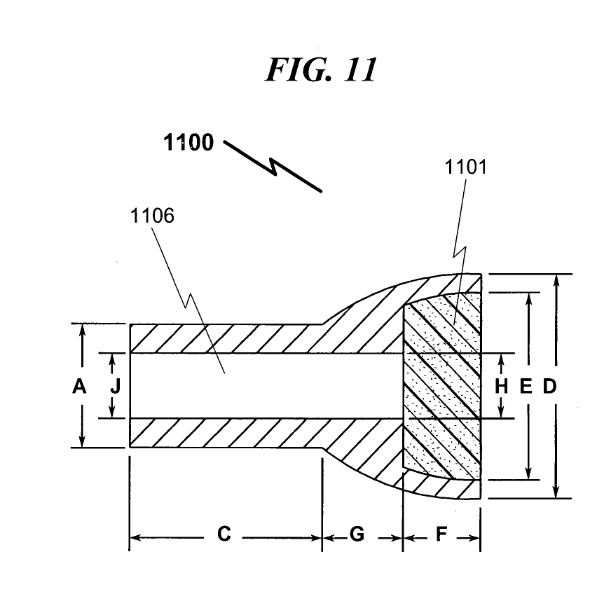

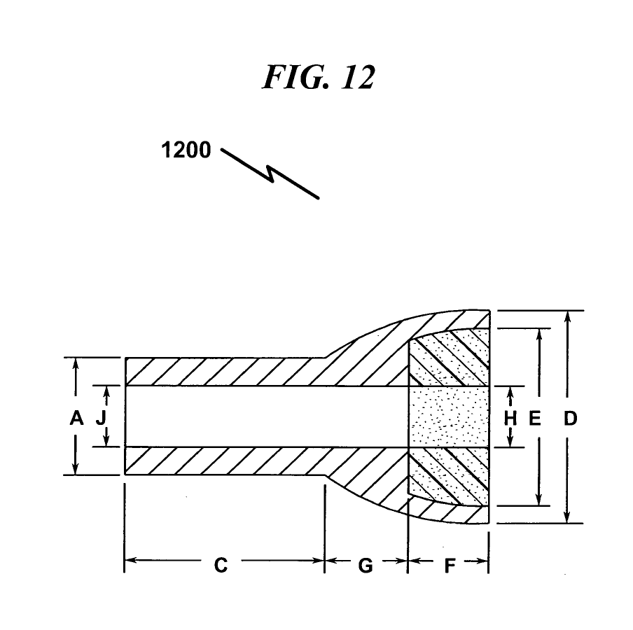

The present invention may also be embodied in a configuration as illustrated in FIG. 11 (1100) and FIG. 12 (1200) wherein the wax guard lip (1004) is not included in the design. In these configurations the cavity (1101) at the end of the hearing aid eartip may be filled with a removable foam insert or other cerumen wax guard.

In this configuration a wide variety of materials may be used to prevent cerumen from contaminating the eartip tube connecting channel (1106), with preferred embodiments utilizing foam that may be replaced if contaminated by wax.

### Dimensions are Exemplary

The present invention may be constructed with a wide variety of materials and dimensions. A preferred system embodiment of the present eartip makes use of the following dimension table, as referenced by the dimension detail identifiers (A,B,C,D,E,F,G,H,J) in FIG. 9 (0900), FIG. 10 (1000), FIG. 11 (1100), and FIG. 12 (1200):

| | | | Alternate |
|---|---|---|---|
| | | Preferred | Preferred |
| Dimension | Dimension | Embodiment | Embodiment |
| Label | Identifier | Value (mm) | Value (mm) |
| A | entry width | 2.70 | 2.70 |
| B | overall length | 8.35 | 8.35 |
| C | entry length | 4.61 | 4.62 |
| D | exit width | 5.00 | 5.00 |
| E | exit diameter | 4.17 | 4.17 |
| F | exit length | 1.86 | 1.86 |
| G | wax guard width | 1.88 | 1.87 |
| H | wax guard | 1.86 | 1.86 |
| | diameter | | |
| J | entry diameter | 1.37 | 1.37 |

The dimensions illustrated in are exemplary and do not represent limitations on the construction or teachings of the present invention. However, in some preferred embodiments, the dimensions illustrated may constitute optimal sizing for many invention applications.

### System Variations

The present invention anticipates a wide variety of variations in the basic theme of construction. The examples presented previously do not represent the entire scope of possible usages. They are meant to cite a few of the almost limitless possibilities.

### CONCLUSION

A hearing aid eartip has been disclosed for use with an over-the-ear hearing aid which incorporates a means for accepting a detachable wax guard for the purposes of preventing wax buildup in the hearing aid sound transmission tube. The disclosed invention is effective at transmitting sound from an over-the-ear hearing aid to the patient's ear canal, is easily inserted into the patient's ear canal, and provides for a more aesthetically pleasing form factor than the prior art. The disclosed invention controls cerumen, improves overall hearing aid gain, and reduces unwanted hearing aid feedback.

1. A hearing aid eartip comprising:
(a) Hearing aid eartip body;
(b) Hearing aid eartip tube mating surface;
(c) Wax guard mating surface; and
(d) Wax guard lip;
wherein
said hearing aid eartip tube mating surface and said wax guard mating surface are connected together and interior to said hearing aid eartip body;
said hearing aid eartip tube mating surface conforms to the outside dimension of a hearing aid eartip tube, said eartip tube connecting said hearing aid eartip to an over-the-ear hearing aid;
said wax guard mating surface conforms to the outside dimension of a detachable wax guard;
said wax guard lip extends distally from said wax guard mating surface and prevents cerumen from contaminating said detachable wax guard when said detachable wax guard is mated with said wax guard mating surface.

2. The hearing aid eartip of claim 1 wherein the entry width of said hearing aid eartip is approximately 2.70 mm.

3. The hearing aid eartip of claim 1 wherein the overall length of said hearing aid eartip is approximately 8.35 mm.

4. The hearing aid eartip of claim 1 wherein the entry length of said hearing aid eartip is approximately 4.61 mm.

5. The hearing aid eartip of claim 1 wherein the exit width of said hearing aid eartip is approximately 5.00 mm.

6. The hearing aid eartip of claim 1 wherein the exit diameter of said hearing aid eartip is approximately 4.17 mm.

7. The hearing aid eartip of claim 1 wherein the exit length of said hearing aid eartip is approximately 1.86 mm.

8. The hearing aid eartip of claim 1 wherein the wax guard width of said hearing aid eartip is approximately 1.88 mm.

9. The hearing aid eartip of claim 1 wherein the wax guard diameter of said hearing aid eartip is approximately 1.86 mm.

10. The hearing aid eartip of claim 1 wherein the entry diameter of said hearing aid eartip is approximately 1.37 mm.

11. A hearing aid eartip comprising:
(a) Hearing aid eartip body;
(b) Hearing aid eartip tube mating surface; and
(c) Wax guard mating surface;
wherein
said hearing aid eartip tube mating surface and said wax guard mating surface are connected together and interior to said hearing aid eartip body;
said hearing aid eartip tube mating surface conforms to the outside dimension of a hearing aid eartip tube, said eartip tube connecting said hearing aid eartip to an over-the-ear hearing aid;
said wax guard mating surface conforms to the outside dimension of a detachable foam wax guard and prevents cerumen from contaminating said eartip tube when said detachable wax guard is mated with said wax guard mating surface.

12. The hearing aid eartip of claim 11 wherein the entry width of said hearing aid eartip is approximately 2.70 mm.

13. The hearing aid eartip of claim 11 wherein the overall length of said hearing aid eartip is approximately 8.35 mm.

14. The hearing aid eartip of claim 11 wherein the entry length of said hearing aid eartip is approximately 4.62 mm.

15. The hearing aid eartip of claim 11 wherein the exit width of said hearing aid eartip is approximately 5.00 mm.

16. The hearing aid eartip of claim 11 wherein the exit diameter of said hearing aid eartip is approximately 4.17 mm.

17. The hearing aid eartip of claim 11 wherein the exit length of said hearing aid eartip is approximately 1.86 mm.

18. The hearing aid eartip of claim 11 wherein the wax guard width of said hearing aid eartip is approximately 1.87 mm.

19. The hearing aid eartip of claim 11 wherein the wax guard diameter of said hearing aid eartip is approximately 1.86 mm.

20. The hearing aid eartip of claim 11 wherein the entry diameter of said hearing aid eartip is approximately 1.37 mm.
